(19) United States
(12) Patent Application Publication
(10) Pub. No.: US 2007/0221442 A1
(43) Pub. Date: Sep. 27, 2007

(54) Folding step

(76) Inventor: Corne Hans R.C., Wevelgem (BE)

Correspondence Address: BACON & THOMAS, PLLC, 625 SLATERS LANE, FOURTH FLOOR, ALEXANDRIA, VA, 22314, US

(21) Appl. No.: 11/727,016

(22) Filed: Mar. 23, 2007

(30) Foreign Application Priority Data
Mar. 24, 2006 (BE) 2006/0180

(51) Int. Cl. E06C 5/00

(52) U.S. Cl. 182/88; 182/127

(57) ABSTRACT

Folding step for a camper (1) or the like, characterized in that it comprises at least two treadboards (3,5), namely a first treadboard (3) and a second treadboard (5) and possibly following treadboards, whereby the first treadboard (3) can be provided in a moving manner on the suspension frame (8) of the camper (1) or the like, and whereby the second treadboard (5) is provided in a moving manner on the first treadboard (3), whereas any following treadboards are provided in a moving manner on one or several of the preceding treadboards, such that the step (2) can be folded at least partly and can be moved in or under the framework (4) of the camper (1) or the like.

The present invention concerns a folding step, in particular a folding step which can be fixed under the door opening of a caravan, camper, house trailer or the like and which can be folded out so as to facilitate the access to the camper or the like.

When the camper or the like is being prepared to be moved, the step can be put away by folding it away and by placing it under the door opening, such that the step will not protrude from under the coachwork in a dangerous manner while driving.

A collapsible step which is held between guiding struts in a movable manner and which is provided with driving means provided between the step and the frame of the camper are already known.

A disadvantage of such a known step is that, in many cases, the difference in height between the ground floor and the step and between the step and the floor area of the camper or the like is still too large.

That is why a step with several treadboards is prescribed.

Besides, new directions and standards regarding the differences in height prescribe a maximum difference in height of 400 mm between the ground floor and the first treadboard, and a difference in height between the different treadboards themselves and between a last treadboard and the floor area of the camper or the like between 200 and 300 mm.

The problem which arises is that a step with several treadboards is difficult to put away, and it is therefore required to provide a step with two or several treadboards which can be stored in a simple manner.

Hence, the present invention concerns a folding step with at least two treadboards, a first treadboard, a second treadboard and possibly following treadboards, whereby the first treadboard is provided in a movable manner on the framework of the camper or the like, and whereby the second treadboard is provided in a movable manner on the first treadboard, whereas any following treadboards are provided on one or several of the preceding treadboards in a moveable manner, such that the step can be folded up at least partly and can be moved in relation to the framework of the camper or the like, whereby the second treadboard is moved up to a height above the stored position when the step is moved from the storage position into the position of use.

An advantage is that such a step can be put away in a very simple manner as the treadboards can assume a position of use, whereby the position of the treadboards mainly corresponds to the position of the treadboards of an ordinary stairway, as well as a more compact, folded position, and that the folded whole can be easily placed for example under the door opening of the camper or the like.

The storing of the step is made easier thanks to the folding character of the step, which as a result may assume a compact volume.

Such a configuration which makes it possible to fold the second treadboard up to a height above the stored position when the step of the storage position is moved into the position of use, results in a very compact, collapsible step which is very suitable to be provided under the door opening of a camper or the like.

Preferably, the step is also provided on the camper or the like in a telescopic manner, or such that it can be tilted away.

In order to better explain the characteristics of the invention, the following preferred embodiment of a folding step according to the invention is given as an example only without being limitative in any way, with reference to the accompanying drawings, in which:

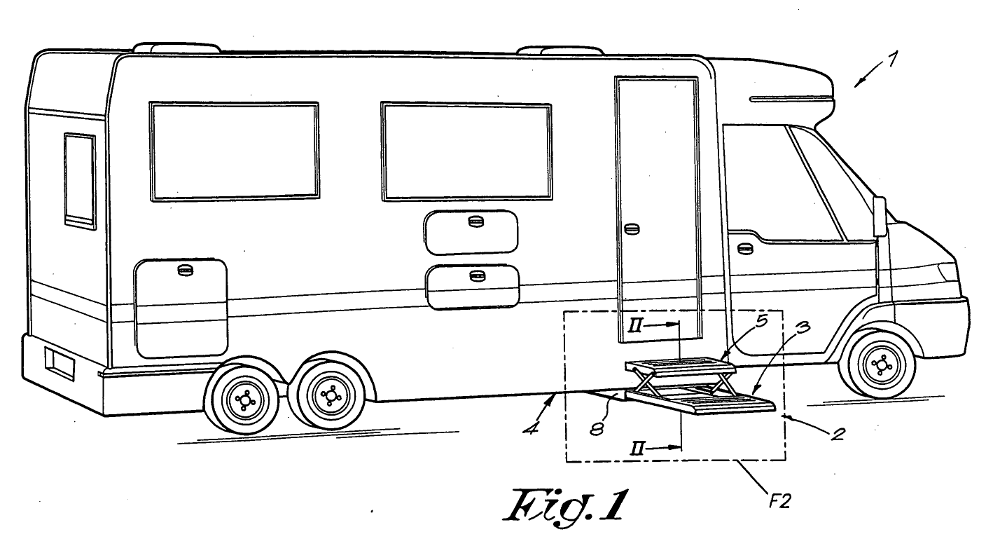

FIG. 1 schematically represents a camper in perspective, provided with a folding step according to the invention;

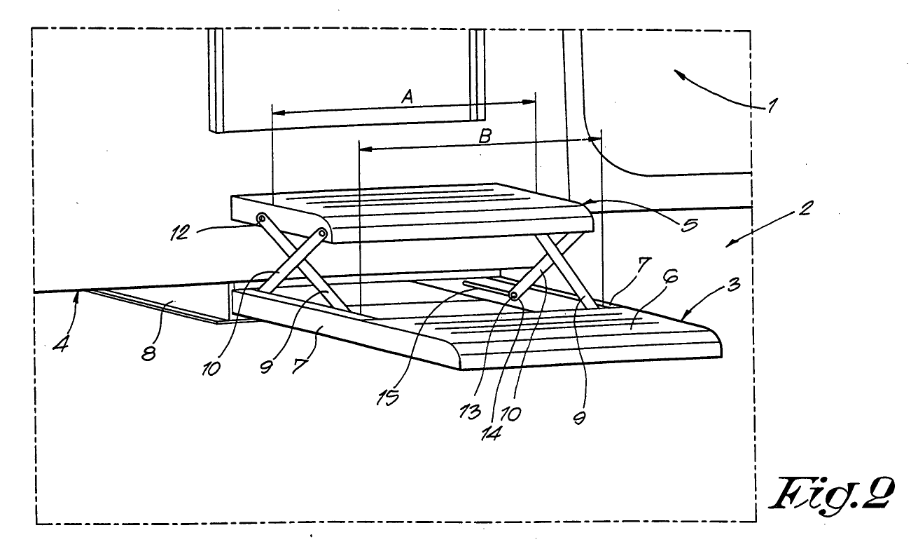

FIG. 2 represents the part indicated by F2 in FIG. 1 to a larger scale;

FIG. 3 represents a step according to line II-II in FIG. 1 to a larger scale and as a section;

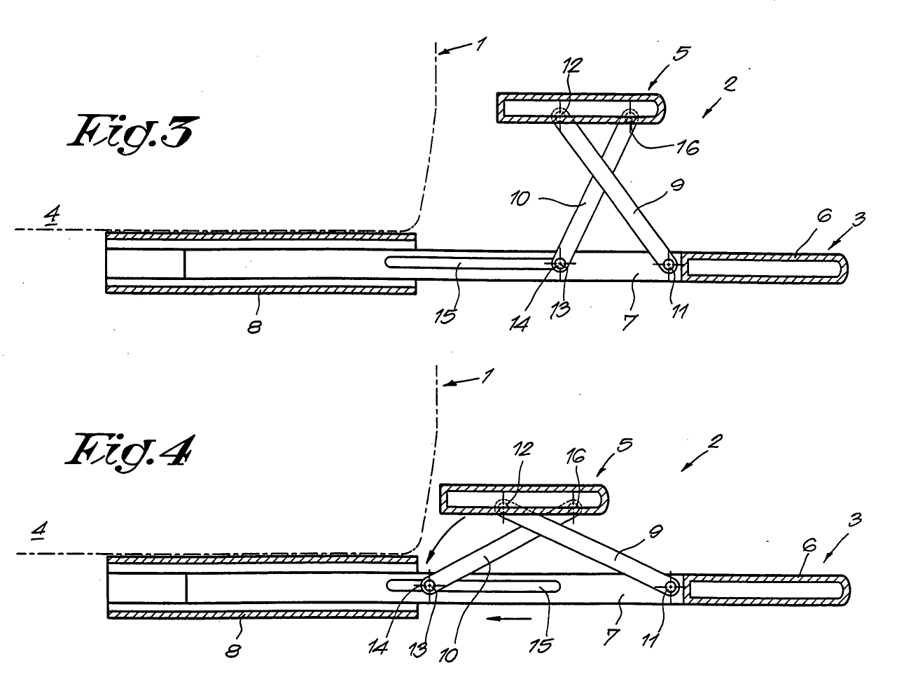

FIGS. 4 to 6 represent three additional characteristic positions of the step according to FIG. 3;

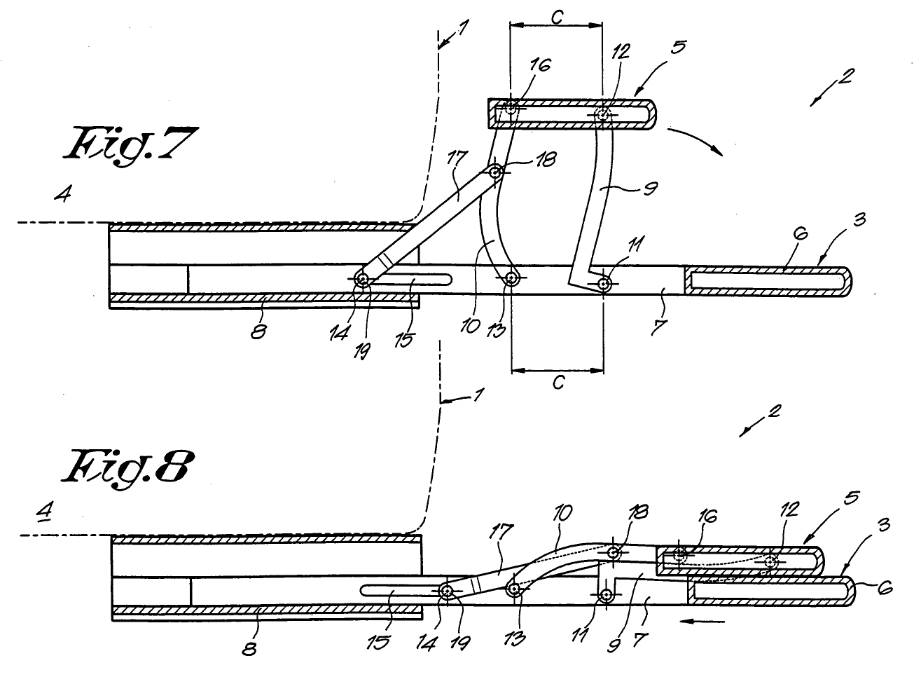

FIGS. 7 to 9 represent three characteristic positions of a variant of the step according to the invention;

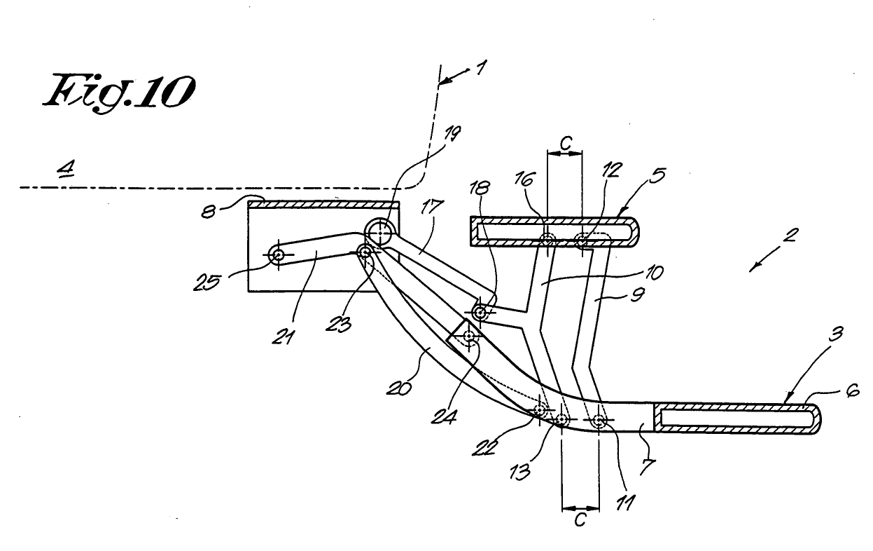

FIGS. 10 and 11 represent two characteristic positions of an additional variant of the step according to the invention.

FIG. 1 represents camper 1 by way of example, provided with a folding step 2 according to the invention, whereby this folding step 2, as is represented more in detail in FIGS. 3 to 6, mainly consists of a first treadboard 3 provided in a sliding manner on the framework 4 of the camper 1 and a second treadboard 5 provided in a moving manner on the first treadboard 3.

The first treadboard 3 mainly consists of a plate 6 and two parallel struts 7 extending as of the sides of the plate 6 up to a distance thereof, whereby the struts 7 are held between two guiding struts 8 forming the suspension frame which is provided on the framework 4.

Between the first treadboard 3 and the second treadboard 5 are provided two pairs of crossed rods here, a first rod 9 and a second rod 10.

The first rod 9 is hinge-mounted to the first treadboard 3 by means of a hinge pin 11 and it is also hinge-mounted to the second treadboard 5 by means of a hinge pin 12.

The second rod 10 is provided with a hinge pin 13 which is connected to the first treadboard 3 in a sliding manner. The hinge pin 13 in particular consists of a pen 14 which is provided in a slot 15. The second rod 10 is also hinge-mounted to the second treadboard 5 by means of a hinge pin 16, such that the first rod 9 and the second rod 10 cross each other.

The second treadboard 5 has a width A which is not larger than the distance B between the struts 7 of the first treadboard 3.

The operation of such a folding step 2 according to the invention is simple and as follows.

Starting from the position of use of the step 2, as represented in FIG. 3, the shifting of the pen 14 in the slot 15 in the direction away from the plate 6, possibly reinforced by means of non-represented driving means, causes a downward movement of the second treadboard 5, as represented in FIG. 4.

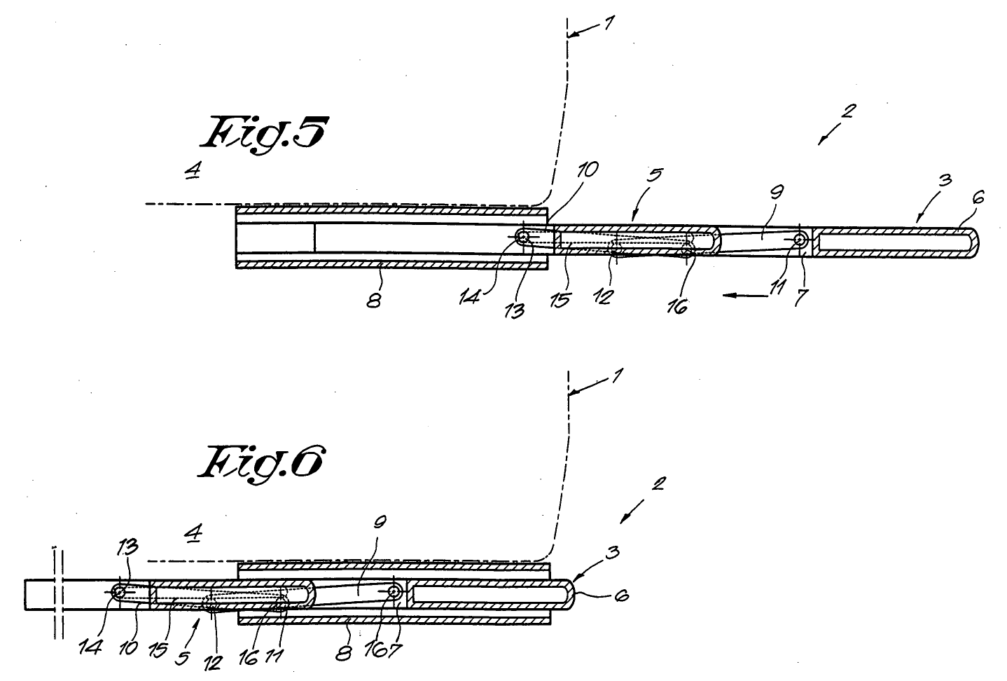

The length of the slot 15 and its positioning is such that the required extreme positions of the second treadboard 5 can be obtained, in particular the unfolded or upward moved position or the position of use of the step 2 on the one hand, and the folded position on the other hand, whereby the second treadboard 5 is positioned between the struts 7, as represented in FIG. 5.

In this folded or collapsed position, the first rods 9 and the second rods 10 are mainly oriented parallel to each other and they are situated in the plane formed by the first treadboard 3.

In this position, the first treadboard 3 and the second treadboard 5 can be shifted between the guiding struts 8, such that the step 2 according to the invention is stored or folded up, as represented in FIG. 6.

The folding character of the step 2 makes it easy to store it or fold it up. The folding step 2 is also characterized in that, when the step 2 is unfolded, the second treadboard 5 is moved up to a height above the stored position. Such a configuration makes it possible to obtain an extremely compact folding step 2 which is very suitable to be provided under the door opening of a camper 1 or the like.

Between the first treadboard 3 and the framework 4 of the camper 1 can be provided first driving means or a spring mechanism, and possibly between the first treadboard 3 and the second treadboard 5, or between the framework 4 and the second treadboard 5 can be provided second driving means or a spring mechanism.

It is clear that the step 2 can be provided with locking means which make it possible to lock the second treadboard 5 in an upward position or a position of use.

FIGS. 7 to 9 represent an alternative embodiment of a folding step 2 according to the invention which is different in that between the first treadboard 3 and the second treadboard 5 are provided two pairs of parallel rotating rods, each time a first rod 9 and a second rod 10.

The first rod 9 is hinge-mounted to the first treadboard 3 by means of a hinge pin 11, and it is also hinge-mounted to the second treadboard 5 by means of a hinge pin 12.

The second rod 10 is hinge-mounted to the first treadboard 3 by means of a hinge pin 13, in particular at a distance C from the hinge pin 11, and it is also hinge-mounted to the second treadboard 5 by means of a hinge pin 16, in particular at the same distance C from the hinge pin 12.

Further, a third rod 17 is provided on each second rod 10, in particular by means of a first hinge pin 18 for the connection to the second rod 10, and by means of a second shifting hinge pin 19, in particular in the form of a shifting pen 14 in a slot 15, for the hinge-mounted and shifting connection of the third rod 17 on the first treadboard 3.

The operation of such a folding step 2 according to the invention is simple and as follows.

Starting from the position of use of the step 2 as represented in FIG. 7, the shifting of the pen 14 in the slot 15 in the direction of the plate 6, possibly reinforced by means of non-represented driving means, causes a downward movement of the second treadboard 5.

The other way round, starting from the storage position as represented in FIG. 9, the shifting of the first treadboard 3, for example as a result of the action of non-represented reinforcement means on the struts 7, makes a first treadboard 3 and a second treadboard 5 extend as a whole from under the framework 4.

By providing locking means on the guiding struts 8 which can act as of a certain extended position of the first treadboard 3 on the pen 14, the pen 14 is kept on the spot while the first treadboard 3 is being extended further, as a result of which the latter will move in the slot 15 in the direction away from the plate 6.

This relative movement of the pen 14 in the slot 15 is accompanied with an upward movement of the second treadboard 5, which configuration makes it possible to obtain an extremely compact folding step 2 which is very suitable to be provided under the door opening of a camper 1 or the like.

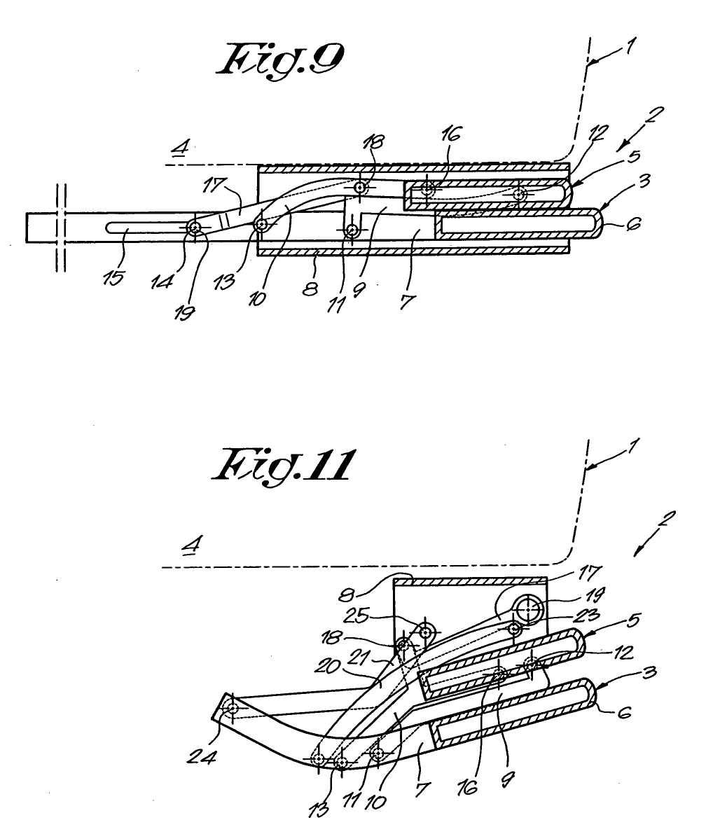

The length of the slot 15 and its positioning is such that the required extreme positions of the second treadboard 5 can be obtained, in particular the above-mentioned position of use on the one hand, and the folded-down position on the other hand, whereby the second treadboard 5 hereby ends up on the plate 6 of the first treadboard, as represented in FIG. 8.

In this position, the first treadboard 3 and the second treadboard 5 can be shifted between the guiding struts 8, whereby sufficient space is provided between the first treadboard 3 and the framework 4 of the camper 1, such that also the second treadboard 5 can be put away in this position under the framework 4, as represented in FIG. 9.

Here as well, between the first treadboard 3 and the framework 4 of the camper 1 can be provided first driving means or a spring mechanism, and possibly between the first treadboard 3 and the second treadboard 5, or between the framework 4 and the second treadboard 5, can be provided second driving means or a spring mechanism.

FIGS. 10 and 11 represent another alternative embodiment of a folding step 2 according to the invention, which mainly differs from the preceding embodiment in two respects.

A first difference consists in that the first treadboard 3 is no longer provided in a shifting manner but in a rotating manner on the framework 4 of the camper 1, in this case in particular via a suspension frame 8. The first treadboard 3 is built of a plate 6 and two struts 7 in this embodiment, which are bent upward in this case.

The first treadboard 3 is suspended in a rotating and storable manner by means of two pairs of rods, each time a first rod 20 and a second rod 21 near both side edges of the step 2.

The first rod 20 is hinge-mounted to the first treadboard 3 by means of a hinge pin 22 and it is hinge-mounted to the suspension frame 8 by means of a second hinge pin 23.

The second rod 21 is hinge-mounted to the first treadboard 3 by means of a first hinge pin 24, and it is hinge-mounted to the suspension frame 8 by means of a second hinge pin 25, such that the first treadboard 3, by turning the above-mentioned rods 20 and 21, can be moved from the unfolded position or the position of use and the folded position under the door opening of the camper 1.

The second difference of this folding step 2, represented in FIGS. 10 and 11, from the step 2 as discussed and as represented in FIGS. 7 to 9, is that the third rod 17 which is hinge-mounted to the second rod 10 by means of a hinge pin 18, is hinge-mounted to the suspension frame 8 provided on the camper 1 by means of a fixed hinge pin 19, as opposed to the shifting hinge pin 19 in the step as represented in FIGS. 7 to 9.

The operation of such a folding step 2 according to the invention is simple and as follows.

Turning the third rod 17 anti-clockwise, possibly with the help of a driving means, and/or turning one or both rods 20 and 21 clockwise, causes a downward movement of the second treadboard 5, and a simultaneous rotation and movement of the first treadboard 3, such that the second treadboard 5 is moved to the plate 6 of the first treadboard 3, as a result of which the step 2 is folded up, whereby the whole is moved under the door opening of the camper 1 and is simultaneously rotated here, as represented in FIG. 11.

The other way round, unfolding the folding step 2 and putting it into use is accompanied with an upward movement of the second treadboard 5. As explained above, such a configuration makes it possible to obtain an extremely compact folding step 2 which is very suitable to be provided under the door opening of a camper 1 or the like.

The positioning of the hinge points and the length of the different rods are such that the desired extreme positions of the first treadboard 3 and the second treadboard 5 can be obtained, in particular the unfolded position of use on the one hand, and the folded storage position under the door opening of the camper 1 on the other hand, whereby the second treadboard hereby ends up on the plate 6 of the first treadboard.

It is clear that driving means or a spring mechanism can be provided here as well between the framework 4 and one or several of the moving parts of the step 2.

Further, the step 2 can also be provided with other elements, such as for example locking means, so as to guarantee that the treadboards remain in a certain position, even when there are no driving means.

The guiding struts 8 which are provided on the framework 4 of the camper 1 can also be part of and/or can be integrated in the camper 1.

The present invention is by no means restricted to the embodiment given as an example and represented in the accompanying drawings; on the contrary, such a folding step according to the invention can be made in all sorts of shapes and dimensions while still remaining within the scope of the invention.

1-11. (canceled)

12. Folding step, useable for example with a camper, comprising at least two treadboards, including at least a first treadboard and a second treadboard, wherein the first treadboard is connectable in a moveable manner to a supporting frame, and wherein the second treadboard is provided in a moving manner on the first treadboard, and wherein any following treadboards are provided in a moving manner on one or several of the preceding treadboards, and wherein the step is foldable at least partly and can be moved to a stored position relative to the supporting frame, and the second treadboard is moved up to a height above the stored position when the step is moved from the stored position into a position of use.

13. Folding step according to claim 12, wherein the first treadboard is rotatable relative to the supporting frame and including at least two rods extending between the first treadboard and the supporting frame, said rods being hinge-mounted to the first treadboard by a first set of hinge pins and being hinge-mounted to the supporting frame by a second set of hinge pins.

14. Folding step according to claim 12, wherein the first treadboard is mounted in a shifting manner relative to the supporting frame.

15. Folding step according to claim 12, wherein between the different treadboards are provided moveable rods.

16. Folding step according to claim 15, wherein between the first treadboard and the second treadboard there is provided at least one pair of crossed rods, including at least a first rod and a second rod, which are hinge-mounted to the first treadboard by a first set of hinge pins, and which are hinge-mounted to the second treadboard by a second set of hinge pins, and wherein at least one of the hinge pins is shiftable on a respective treadboard, such that said shifting of the hinge pin enables the second treadboard to be moved from a position of use, wherein the rods are disposed in a mutually crossed position, into a folded position, to facilitate storing of the step.

17. Folding step according to claim 16, wherein the shifting hinge pin is provided on the first treadboard.

18. Folding step according to claim 15, wherein between the first treadboard and the second treadboard is provided at least one pair of parallel, rotating rods, including a first rod and a second rod, which rods are hinge-mounted to the first treadboard by a first set of hinge pins at a distance D from each other, and which are hinge-mounted to the second treadboard by a second set of hinge pins at the same distance D from each other, and a third rod which is hinge-mounted to one of said parallel, rotating rods by a respective hinge pin, and which third rod is hinge-mounted to the first treadboard or to the supporting frame in a shifting manner by means of a shifting hinge pin, such that the shifting of the hinge pin of the third rod enables the second treadboard to be moved from an unfolded position of use into a folded position, as a result of which storing of the step is facilitated.

19. Folding step according to claim 15, wherein between the first treadboard and the second treadboard there is provided at least one pair of parallel, rotating rods, including a first rod and a second rod, which rods are hinge-mounted to the first treadboard by a first set of hinge pins at a distance D from each other, and which are hinge-mounted to the second treadboard by a second set of hinge pins at the same distance D, and a third rod which is hinge-mounted to one of the parallel, rotating rods by a respective hinge pin, and which third rod is hinge-mounted to the supporting frame by means of a respective hinge pin, so that rotating the third rod causes the second treadboard to be moved from an unfolded position of use into a folded position, such that storing of the step is facilitated.

20. Folding step according to claim 12, wherein between at least the first treadboard and the second treadboard, two sets of rods are provided.

21. Folding step according to claim 20, wherein the arrangement of the first treadboard, the second treadboard and the rods in between is configured to enable the second treadboard to be placed in a plane including the first treadboard.

22. Folding step according to claim 12, including a driving arrangement arranged to assist in at least one of folding and unfolding of the step between stored and use positions.
